(19) United States
(12) Patent Application Publication
(10) Pub. No.: US 2009/0206293 A1
(43) Pub. Date: Aug. 20, 2009

(54) Flow Controller with Channel Having Deformable Wall

(76) Inventors: Timothy Beerling, San Francisco, CA (US); Harry F. Prest, Santa Cruz, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/032,419

(22) Filed: Feb. 15, 2008

(51) Int. Cl. F16K 7/12

(52) U.S. Cl. 251/331

(57) ABSTRACT

An apparatus and method for controlling the flow of fluid though a channel. A first substrate defines features comprising a first channel. At least a portion of the first channel is bounded a deformable material having a first contour in which the first channel has a first cross-sectional area and a second contour in which the first channel has a second cross-sectional area.

### BACKGROUND

Systems for analyzing a fluid or the analytes within the fluid involve conducting the fluid along a pathway from a source to a detector. The fluid is typically controlled while the fluid stream flows along the pathway. For example, the fluid might pass through a splitter that divides the fluid into separate fluid paths and carries the divided fluid streams to separate detectors. The fluid stream also might pass through a resistive element to control the flow rate and pressure of fluid.

A problem is that many fluid pathways are very small and it is difficult to place fluid control mechanisms in the pathway. In microfluidic structures, for example, the fluid pathways have dimensions in the micrometer range and the fluid pathways for nanotechnology are even smaller. Such fluid pathways are too small to include traditional mechanical valve members, which are bulky and require seals that add complexity and require additional space.

There are typically two options to change the flow characteristics in such a microfluidic device. The microfluidic device can be replaced with another one that has different flow characteristics. Alternatively, an external flow control device such as a restrictor column can be placed in the fluid pathway, but external to the device having the microfluidic pathway. Both of these situations require a lab to maintain additional hardware, which is expensive and takes up space. Additionally, external flow controllers require additional time to set up the instrumentation. Furthermore, the external flow control devices such as restrictor columns can be fragile and subject to breakage.

### BRIEF DESCRIPTION OF THE DRAWINGS

FIG. 1 is a plan view of one possible embodiment of a flow controller having a channel and a deformable wall;

FIGS. 2A and 2B are cross-sections of the flow controller shown in FIG. 1 and taken along lines 2A-2A and 2B-2B, respectively, with a deformable material having a first contour and a second contour, respectively;

FIGS. 3A and 3B are cross-sections of an alternative embodiment of the flow controller shown in FIG. 1 and taken along lines 3A-3A and 3B-3B, respectively, with a deformable material having a first contour and a second contour, respectively, the flow controller having an alternative embodiment of the channel;

FIG. 4 shows a graph of experimental data from an experiment using the apparatus illustrated in FIG. 1;

FIG. 5 is a plan view of a flow splitter incorporating an embodiment of a flow splitter embodying the flow controller shown in FIG. 1 and having a network of channels;

FIGS. 6A and 6B are cross-sections of the flow splitter shown in FIG. 5 taken along lines 6A-6A and 6B-6B, respectively, with the deformable material of the flow controller having a first contour and a second contour, respectively;

FIG. 6C is a cross-section of an alternative embodiment of the flow splitter shown in FIG. 5 and taken along line 6C-6C, the flow splitter having an alternative embodiment of the channels.

FIG. 7 is a top-plan view of an alternative embodiment of a flow splitter;

FIG. 8 is a cross-section of the flow splitter shown in FIG. 7, taken along line 8-8;

FIG. 9 is a top-plan view of another alternative embodiment of a flow splitter;

FIG. 10 is a cross-section of the flow splitter shown in FIG. 9, taken along line 10-10;

FIG. 11 illustrate one application for the flow splitter illustrated in FIG. 5; and

FIG. 12 illustrates an alternative application for the flow splitter illustrated in FIG. 5;

FIG. 13A and 13B are cross-sections of the flow controller shown in FIGS. 1, 2A, and 2B, with a mechanical mechanism urging the deformable material from the first contour and the second contour; and

FIG. 14 is a flow chart of the basic operation of a flow splitter shown in FIG. 5.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

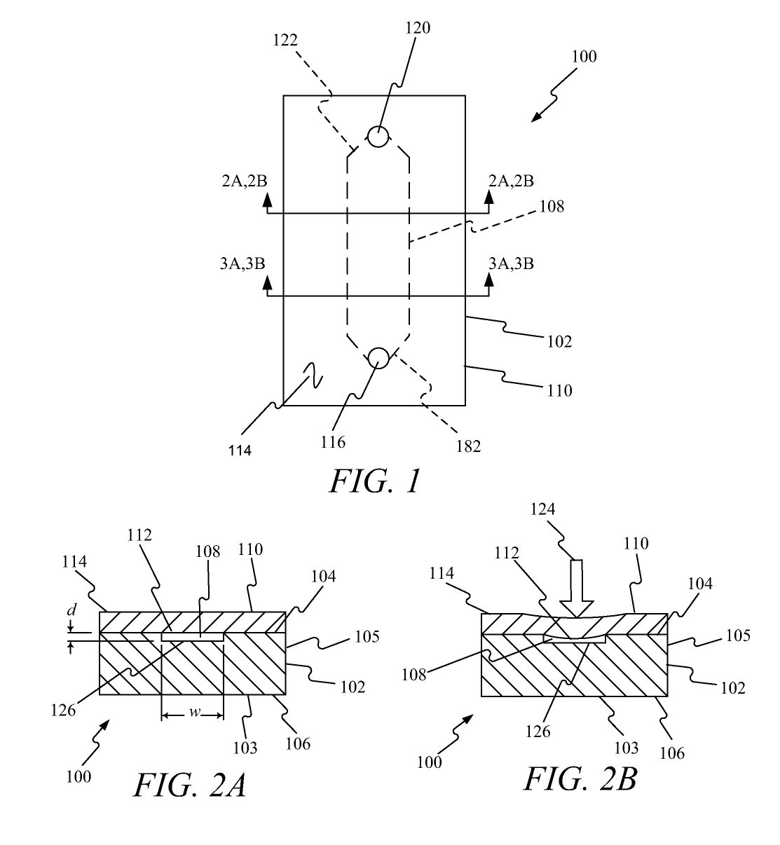

Turning now to FIGS. 1, 2A, and 2B, a flow controller, generally shown as 100, includes a substrate 102 that has a first surface 104 and a second surface 106 that is disposed opposite the first surface 104. The substrate 102 defines a channel 108 that provides a fluid pathway. The flow controller 100 also includes a deformable material 110 positioned over at least a portion of the first surface 104. The deformable material 110 has an internal surface 112 that provides a deformable wall bounding the channel 108. The deformable material 110 also has an external surface 114 that is external to the channel 108. The deformable material 110 provides a resistive element for controlling the flow of fluid through the channel 108. The deformable material 110 also enables the fluid flow to be controlled without a conventional mechanical member, whether internal or external to the flow controller 100. It also enables control of the fluid flow without a separate resistive element such as a restrictor column external to the flow controller 100. An inlet via 116 extends through the deformable material 110 at a first end 118 of the channel 108 and an outlet via 120 extends through the deformable material 110 at a second end 122 of the channel 108.

In other embodiments, however, the inlet via 116 and outlet via 120 extend through the substrate 102 and do not extend through the deformable material 110. For example, the inlet and outlet vias 116 and 120 have one end that opens into the channel 108 and an opposite end that opens to a bottom surface 103 of the substrate 102. In another example, the inlet and outlet vias 116 and 120 have one end the opens into the channel 108 and an opposite end that opens to a sidewall surface 105 of the substrate 102. In these alternative embodiments, there is no need to register vias defined in the deformable material with the channel 108.

The channel 108 is a microchannel for conducting microfluidic volumes of fluid at a mass flow rate of about 1 mg/sec or less. The channel 108 has a width, w, and a depth, d. The width is substantially greater than the depth. In this context, “substantially” means that the width is greater than the depth to such a degree that a slight deflection of the deformable material 110 into the channel 108 will appreciably decrease the cross-sectional area of the channel 108. Such decrease in the cross-sectional area of the channel 108 creates an increased resistance in the flow of fluid though the channel 108.

In an exemplary embodiment, the cross-sectional area of the channel 108 when the deformable material 110 is not deformed is in the range of about 50 μm² to about 0.1 mm². The width, w, is in a range of about 10 μm to about 2 mm, and the depth, d, is in a range of about 5 μm to about 100 μm. The cross-sectional area has an aspect ratio of width, w, to depth, d, in a range of about 2 to about 200. In another example, the width, w, is about 1000 μm and the depth, d, is about 20 μm. The deformable material 110 is a membrane having a thickness of about 50 μm. In other example, the deformable material 110 has a thickness in the range of about 5 μm to about 200 μm. “About,” when used with a value provided herein, means that the value is within an acceptable tolerance or is otherwise reasonably close to the stated value such that flow controller 100 still operates as described herein.

Additionally, the deformable material 110 can span the entire length and width of the channel 108 or only a portion of the channel 108. If the deformable material 110 does not bound the entire channel 108, the portions of the channel 108 not covered by the deformable material 110 are covered with a substrate or some other structure that encloses the channel 108.

In operation, still referring to FIGS. 1, 2A, and 2B, a fluid flows into the inlet via 116, through the channel 108, and exits through outlet via 120. To adjust the flow rate through the channel 108 and the outlet via 120, a force 124 is applied to the deformable material 110 at a location along the channel 108 between the inlet via 116 and the outlet via 120. The force 124 urges the deformable material 110 into the channel 108 (FIG. 2B) and changes the shape of the deformable material from a first contour (FIG. 2A) to second contour (FIG. 2B). The force 124 can be applied to the deformable material 110 across the entire width of the channel 108, along a portion of the width of the channel 108, along the entire length of the channel 108, or along a portion of the length of the channel 108, or in a combination of the foregoing.

The channel 108 has a first cross-sectional area when the deformable material 110 has the first contour and a second cross-sectional area when the deformable material has the second contour. The cross-sectional area of the channel 108 decreases when the deformable material 110 changes from the first contour (FIG. 2A) to the second contour (FIG. 2B). The reduced cross-sectional area of the channel increases resistance to the flow of fluid and, when the fluid pressure at the inlet via 116 is held constant, decreases the flow rate of the fluid through the channel 108 and the outlet via 120. Fluid pressure is typically held constant in applications such as gas chromatography. Although the deformable material 110 is illustrated changing between first and second contours, other embodiments change the deformable material 110 through more than two contours and change the cross-section of the channel 108 between more than two cross-sectional areas. In one embodiment, for example, the deformable material 110 changes between first, second, and third contours and the channel 108 changes between first, second, and third cross-sectional areas, respectively.

In an alternative embodiment, the flow rate of the fluid flowing through the outlet via 120 is measured. The force 124 applied to the deformable material 110 is adjusted to change the contour of the deformable material 110, which changes the cross-sectional area of the channel 108. The measuring and the adjusting are repeated until the flow rate through the outlet via 120 is at a target level.

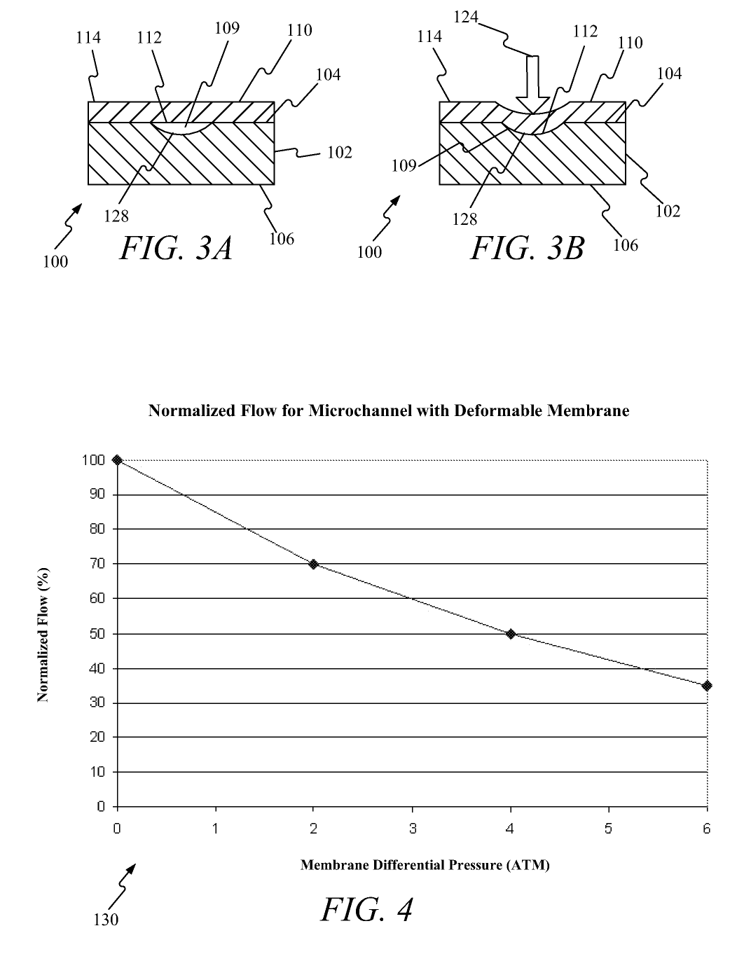

Referring to FIGS. 3A and 3B, alternative embodiments can selectively regulate the flow rate and can additionally reduce the flow rate to zero. In these embodiments, the substrate 102 defines a channel 109 having a curved wall 128 opposite the deformable material 110. The curved wall 128 and the deformable material 110 bound the channel 109. In this embodiment, as illustrated in FIG. 3B, the force 124 applied to the deformable material 110 is sufficient to urge the deformable material 110 into the channel 109 and to change the deformable material 110 to a second contour that generally conforms to the curved wall 128. In this context, the term “generally” means that the second contour is not required to conform exactly to the curved wall 128. It is enough that the second contour reduces the cross-sectional area of the channel 109 to one sufficiently small as to prevent the flow of fluid through the channel 109. The embodiment illustrated in FIGS. 3A and 3B can be used as a flow rate regulator similar to the embodiment illustrated in FIGS. 1, 2A, and 2B and can additionally be used as an on/off valve.

In the embodiment described above with reference to FIGS. 2A and 2B, the channel 108 has a rectangular cross-sectional shape when the deformable material 110 has the first contour illustrated in FIG. 2A. In the embodiment described above with reference to FIGS. 3A and 3B, the channel 109 has the cross-sectional shape of a segment of a circle when the deformable material 110 has the first contour illustrated in FIG. 3A. However, other embodiments have different cross-sectional shapes including symmetrical and nonsymmetrical shapes and shapes comprising straight lines and curved lines.

Furthermore, FIG. 2B illustrates the channel 108 having enough cross-sectional area to allow fluid to flow, while FIG. 3B illustrates the cross-sectional area of channel 109 being reduced such that the fluid flow is blocked. The force 124 applied to the deformable material 110 can be adjusted in both embodiments so that the channel 108 or 109 can be obstructed enough to block the fluid flow. If the deformable material 110 is to obstruct the channel 108 sufficiently to stop fluid flow, the deformable material 110 is sufficiently compliant so it can conform to the cross-sectional shape of the channel 108 to stop the fluid flow. Additionally, when stopping the flow of fluid through the channel 108, the force 124 is applied in a manner that urges the deformable material 110 into the corners of the channel walls so that the deformable material 110 conforms to the cross-sectional shape of the channel 108. Similarly, the channel 109 can be restricted, but left open enough, to continue allowing fluid flow.

### EXAMPLE

Referring to FIG. 4, the graph 130 presents membrane differential pressure in atmospheres versus the percent of normalized flow through a channel. A channel having a width of about 1000 μm and a depth of about 20 μm was etched into a titanium substrate. A polyimide membrane having a thickness of about 50 μm was positioned over the substrate so that it covered the channel. Helium gas was input into one end of the channel and maintained at a constant pressure, and the flow rate was measured at the output of the channel. A force was exerted on a portion of the polyimide membrane located opposite the channel to urge the membrane into the channel. The membrane is subject to a differential pressure, which is the difference between the force applied to the polyimide membrane per unit of area to which the force is applied and the pressure exerted against the polyimide membrane by fluid flowing through the channel. The force applied to the polyimide membrane was varied the change the differential pressure from about 0 atmospheres (˜0 Pa) to about 6 atmospheres (˜608 kPa). Defining the flow rate through the channel when the differential pressure was zero as an initial flow rate, the flow rate through the channel was about 35% of the initial flow rate when the differential pressure was 6 atmospheres.

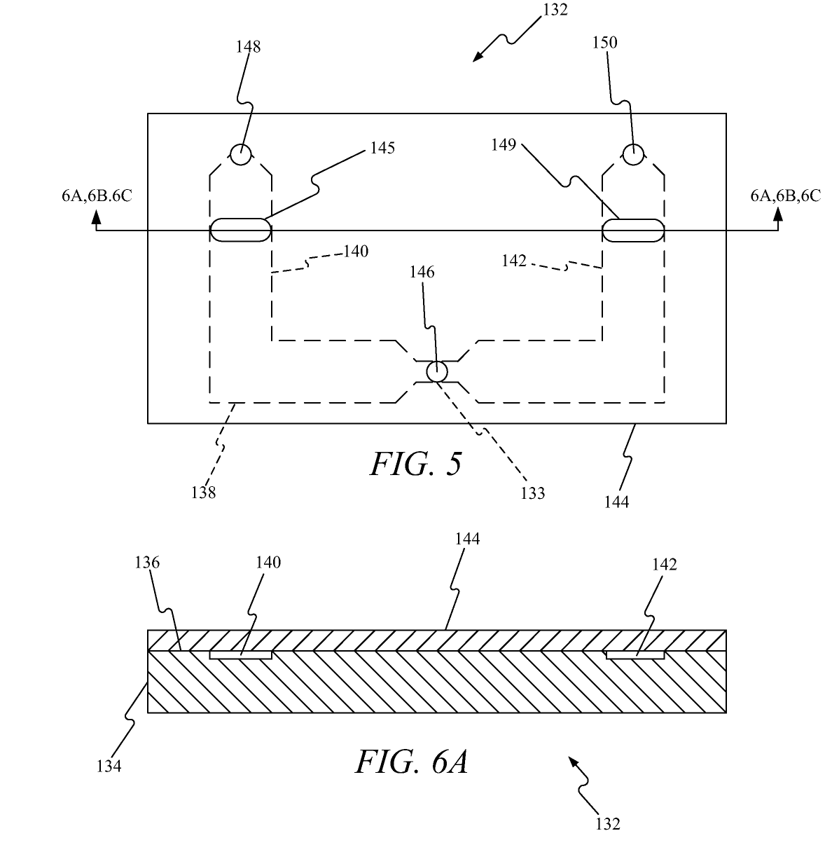

FIG. 5 illustrates a flow splitter, generally shown as 132, comprising an embodiment of a flow controller in accordance with an embodiment of the invention. A substrate 134 has a surface 136 and defines a network of channels 138. The network 138 includes a first channel 140 and a second channel 142. Each of the channels 140, 142 is open to the surface 136. A deformable material 144 is positioned over at least a portion of the surface 136 and covers the network of channels 138, including the first and second channels 140 and 142.

An inlet via 146 extends through the deformable material 144 and is in fluid communication with the network of channels 138. The inlet via 146 provides an inlet port for fluid flowing into the network of channels 138. The inlet via 146 is located at the junction between the first and second channels 140 and 142. A first outlet via 148 extends through the deformable material 144 and is in fluid communication with the first channel 140 at a location spatially separated from the inlet via 146. The first outlet via 148 provides a port for fluid flowing through the first channel 140 and out of the network of channels 138. A second outlet via 150 extends through the deformable material 144 and is in fluid communication with the second channel 142 at a location spatially separated from the inlet via 146. The second outlet via 150 provides a port for fluid flowing through the second channel 142 and out of the network of channels 138. In other embodiments, the inlet and outlet vias extend through the substrate and do not extend through the deformable material 144.

A region 133 of the first channel 140 provides fluid communication to the second channel 142. The region 133 can be an opening in a wall of the first channel 140 through which fluid can flow between the first and second channels 140 and 142. Because the inlet via 146 is located at the junction between the first and second channels 140 and 142, the inlet via 146 is collocated with the region 133 and simultaneously communicates fluid directly into both the first and second channels 140 and 142. In alternative embodiments, the second channel 142 branches off the first channel 140 at a location along the first channel 140 and downstream from the inlet via 146 (i.e., between the inlet via 146 and the first outlet via 148).

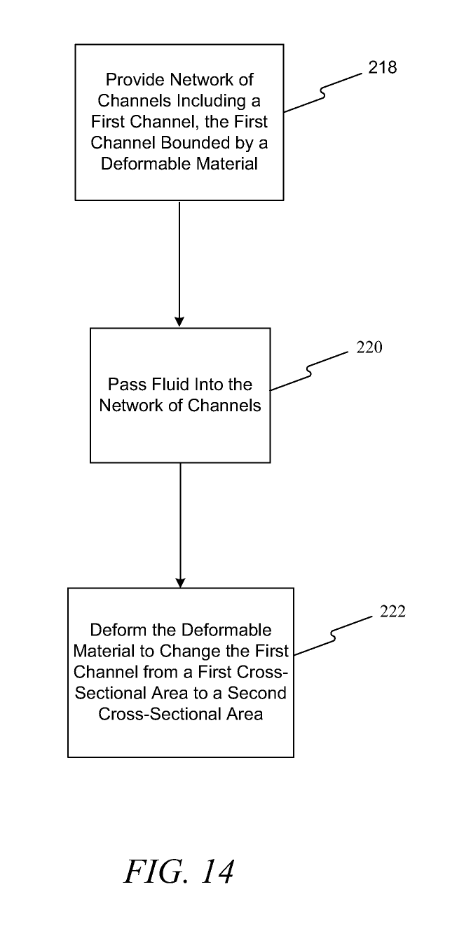

In general terms and with reference to FIG. 14, operation of the flow splitter 132 includes several operations. Operation 218 is providing a network of channels 138 comprising a first channel 140. The first channel 140 is bounded by a deformable material. In operation 220, fluid is passed into the network of channels 138. At operation 222, the deformable material bounding the first channel 140 is deformed to change the first channel 140 from a first cross-sectional area to a second cross-sectional area. Deforming a portion of the deformable material 144 bounding the first channel 140 provides a resistive element for controlling the fluid flow. The deformation occurs at a location between the region 133 and the first outlet via 148. In the embodiment illustrated in FIG. 5, the location of the deformation is located anywhere between the inlet via 146 and the first outlet via 148.

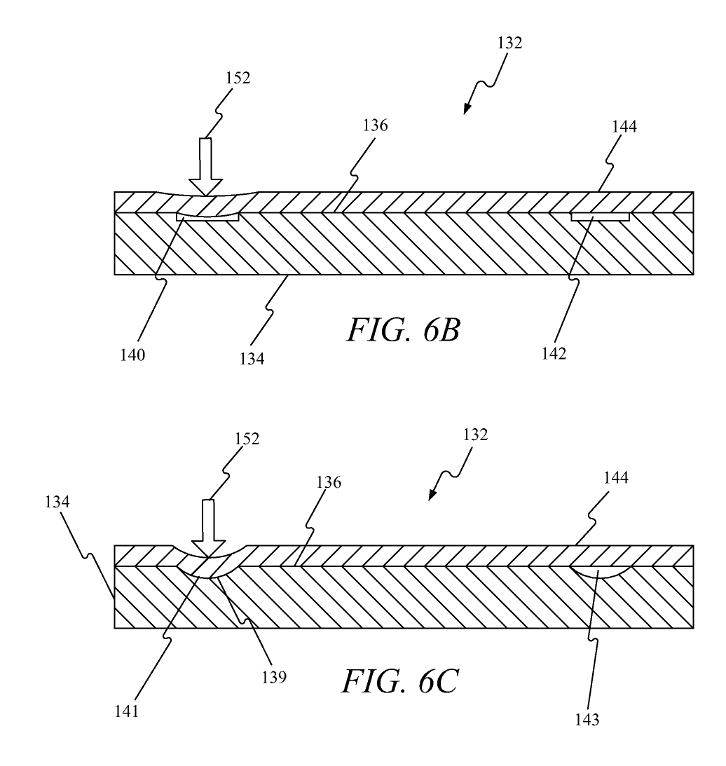

Referring now to FIGS. 5, 6A, and 6B, during operation a fluid flows through the inlet via 146 and into the network of channels 138. The flow of fluid entering network of channels 138 through inlet via 146 splits between the first and second channels 140 and 142. A portion of the fluid flows to the first outlet via 148 through the first channel 140. The remainder of the fluid flows to the second outlet via 150 through the second channel 142. To adjust the ratio of the flow rates through the first and second outlet vias 148 and 150, a force 152 is applied to the deformable material 144 at a location 145 along the first channel 140 between the inlet via 146 and the first outlet via 148. The force 152 urges the deformable material 144 into the first channel 140 (FIG. 6B) and changes the shape of the deformable material 144 from a first contour (FIG. 6A) to second contour (FIG. 6B). Although the force 152 is illustrated as being applied in a location 145 of the first channel 140, the force 152 can be applied to the deformable material 144 across the entire width of the first channel 140, along a portion of the width of the first channel 140, along the entire length of the first channel 140, along a portion of the length of the first channel 140, or along a combination of the foregoing.

In alternative embodiments, the force 152 is applied at a location 149 along the second channel 142 between the inlet via 146 and the second outlet via 150. In yet other embodiments, forces can be applied to both location 145 corresponding to the first channel 140 and location 149 corresponding to the second channel 142.

When the fluid pressure at the inlet via 146 is held constant and the applied force 152 changes the deformable material 144 from the first contour (FIG. 6A) to the second contour (FIG. 6B), the flow rate through the first outlet via 148 decreases as the cross-sectional area of the first channel 140 decreases and the flow rate of fluid through the second outlet via 150 remains constant. Changing the flow rate through the first outlet via 148 while maintaining a constant flow rate through the second outlet via 150, changes the ratio of flow rates through the first and second outlet vias 148 and 150.

The flow rate of fluid through the first outlet via 148 may be measured and the force 152 exerted against the deformable material 144 changed until the flow rate through the first outlet via 148 reaches a target level. Alternatively, the flow rates of fluid through both the first and second outlet vias 148 and 150 are measured and the force 152 is adjusted until the ratio of flow rates through the first and second outlet vias 148 and 150 reaches a target value.

Referring to FIG. 6C, an alternative embodiment of the flow splitter 132 can selectively regulate the flow rate and can additionally reduce the flow rate to zero. In this embodiment, the substrate 134 defines a first channel 141 having a curved wall 139 and a second channel 143 having a curved wall 135. The deformable material 144 bounds the first and second channels 141 and 143. In this embodiment, the force 152 applied to the deformable material 144 is sufficient to urge the deformable material 144 into the first channel 141 and to change the deformable material 144 to a second contour that generally conforms to the curved wall 139.

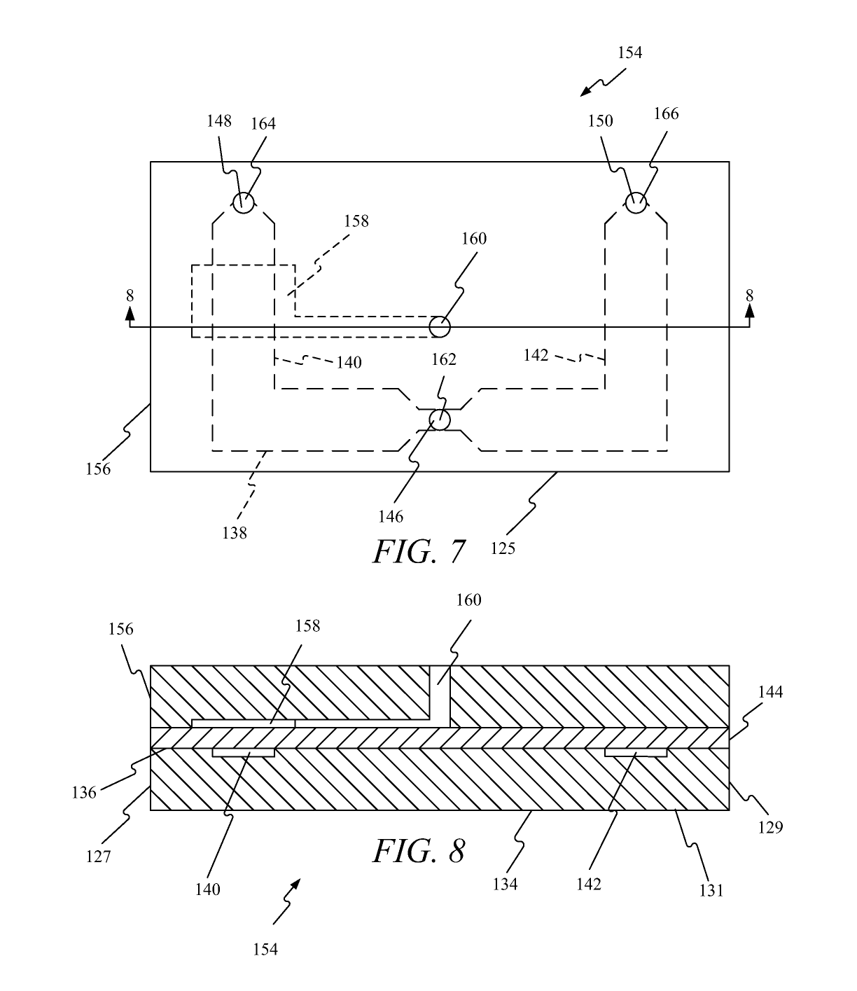

FIGS. 7 and 8 illustrate an alternative embodiment of a flow splitter, generally shown as 154. Flow splitter 154 is similar to the flow splitter 132 illustrated in FIG. 5 and includes the first substrate 134 defining the network of channels 138 and the deformable material 144 defining the inlet via 146, the first outlet via 148, and the second outlet via 150. A second substrate 156 is positioned so the deformable material 144 is sandwiched between the first and second substrates 134 and 156. The second substrate 156 defines a cavity 158 open to the deformable material 144. At least a portion of the cavity 158 is located directly opposite a lengthways portion of the first channel 140. In alternative embodiments, the cavity 158 can extend across the entire width of the first channel 140, across only a portion of the width of the first channel 140, along the entire length of the first channel 140, or along only a portion of the length of the first channel 140, or any combination thereof.

The second substrate 156 defines a pressure via 160 that extends through the second substrate 156 into fluid communication with the cavity 158. The second substrate 156 also defines an inlet via 162 axially aligned with and in fluid communication with the inlet via 146 defined in the deformable material 144, a first outlet via 164 axially aligned with and in fluid communication with the first outlet via 148 of the deformable material 144, and a second outlet via 166 in fluid communication with the second outlet via 150 defined in the deformable material 144. In alternative embodiment, the inlet and outlet vias extend through the first substrate 134 and do not extend through the deformable material 144 or the second substrate 156. For example, the inlet via has one end that opens into the junction of the first and second channels 140 and 142 and an opposite end that opens to a bottom surface 131 or side surface 125 of the first substrate 134. Similarly, the first outlet via has one end that opens to the first channel 140 and an opposite end that opens to the bottom surface 131 or a side surface 127; and the second outlet via has one end that opens to the second channel 142 and an opposite end that opens to the bottom surface 131 or a side surface 129.

In operation, a pressurization fluid is input to cavity 158 through the pressure via 160. The pressurization fluid is input to the cavity 158 until it exerts enough force against the deformable material 144 to urge the deformable material 144 into the first channel 140 and change the shape of the deformable material 144 from the first contour to the second contour.

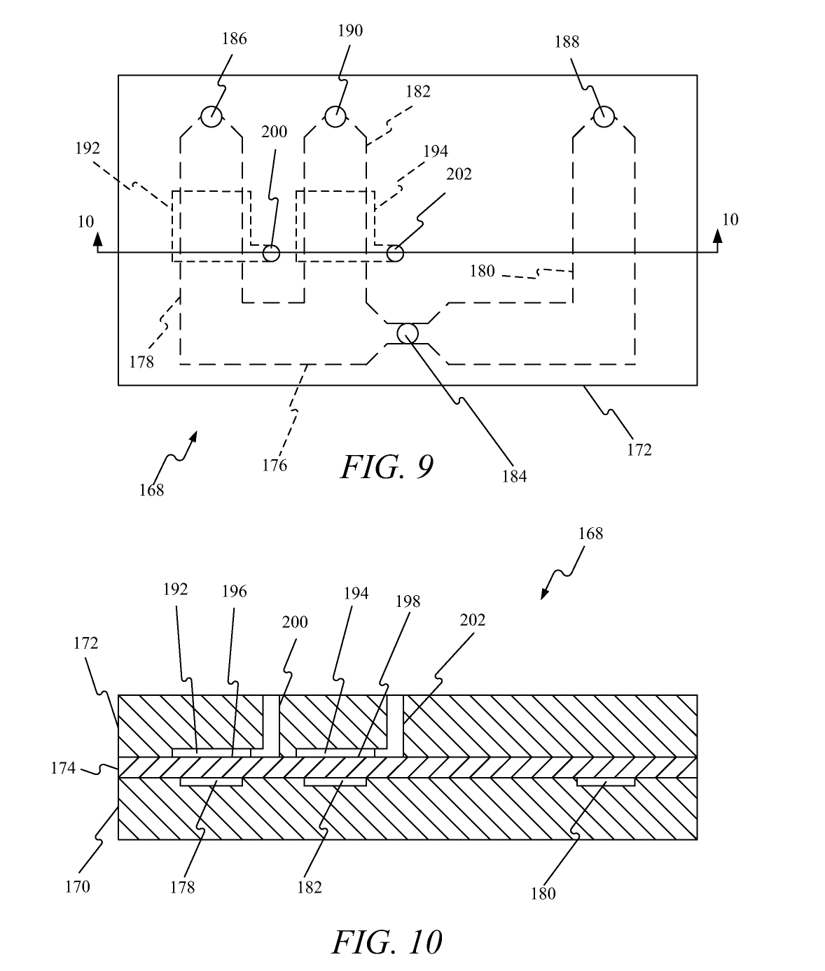

FIGS. 9 and 10 illustrate another alternative embodiment of a flow splitter, generally shown as 168. Flow splitter 168 has a first substrate 170, a second substrate 172, and a deformable material 174 positioned between the first and second substrates 170 and 172. The first substrate 170 defines a network of channels 176 that includes first, second, and third channels 178, 180, and 182. The deformable material 174 and the second substrate 172 define an inlet via 184 in fluid communication with the network of channels 176, a first outlet via 186 in fluid communication with the first channel 178, a second outlet via 188 in fluid communication with the second channel 180, and a third outlet via 190 in fluid communication with the third channel 182. The second substrate 172 defines first and second cavities 192 and 194 open to first and second portions 196 and 198 of the deformable material 174, respectively. The second substrate 172 also defines first and second pressure vias 200 and 202 in fluid communication with the first and second cavities 192 and 194, respectively. At least a portion of the first cavity 192 directly opposes the first channel 178 at a location between the inlet via 184 and the first outlet via 186. At least a portion of the second cavity 194 directly opposes the third channel 182 at a location between the inlet via 184 and the third output via 190.

In operation, pressurization fluid is input through the first and second pressure vias 200 and 202 into the first and second cavities 192 and 194, respectively. Pressurization fluid is input to the first cavity 192 until it exerts enough force against the deformable material 174 to urge the first portion 196 of the deformable material 174 into the first channel 178 to through the first outlet via 186. Urging the first portion 196 of the deformable material 174 into the first channel 178 changes the deformable material 174 from a first contour to a second contour. Pressurization fluid is input to the second cavity 194 until it exerts enough force against the deformable material 174 to urge the second portion 198 of the deformable material 174 into the third channel 182 to decrease the cross-sectional area of the third channel 182 and reduce the flow rate of the fluid through the third outlet via 190. Urging the deformable material 174 into the third channel 182 changes the deformable material 174 to a third contour.

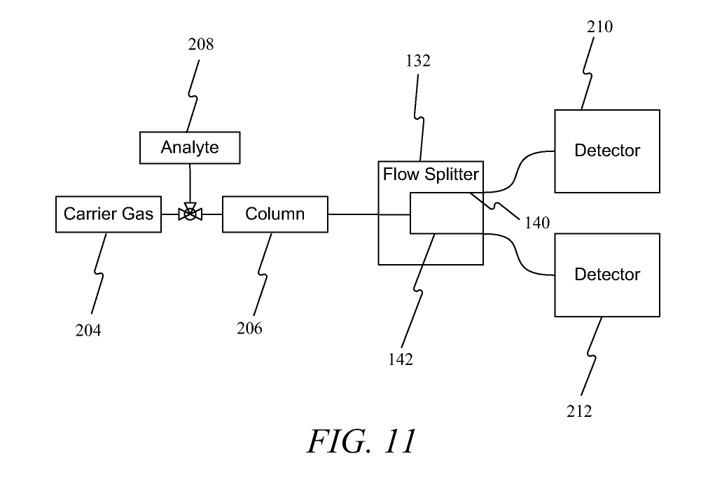

The flow splitters disclosed herein can be used in a variety of different applications. For example, with reference to FIG. 11, the flow splitter 132 is used in gas chromatography. A stream of carrier gas is supplied from a pressurized tank 204 and flows into a gas chromatography (GC) column 206. Analytes 208 are injected into the gas stream upstream from the GC column 206. The GC column 206 separates the analytes 208 in the gas stream, which then flows into the flow splitter 132 at a constant pressure. The flow splitter 132 controllably splits the gas stream between the first channel 140 and the second channel 142. The first channel 140 guides a portion of the carrier gas toward a first instrument 210 and the second channel 142 guides the remainder of the carrier gas to a second instrument 212. The flow rate of carrier gas through the flow splitter 132 is set at a target level as described in more detail above. In this example embodiment, the flow splitter 132 provides a restrictor to regulate the flow rate of the carrier gas.

The first and second instruments 210 and 212 can be selected from a variety of instruments used in chromatography. Examples of instruments include detectors such as mass spectrometers, evaporative light-scattering detectors, electrochemical detectors, flame ionization detectors, thermal conductivity detectors, discharge ionization detectors, electron capture detectors, flame photometric detectors, Hall electrolytic conductivity detectors, helium ionization detectors, nitrogen phosphorus detectors, mass selective detectors, photo-ionization detectors, pulsed discharge ionization detectors, and radioactivity detectors. Another example of instruments includes additional GC columns to further separate analytes in the gas stream before they are input to a detector.

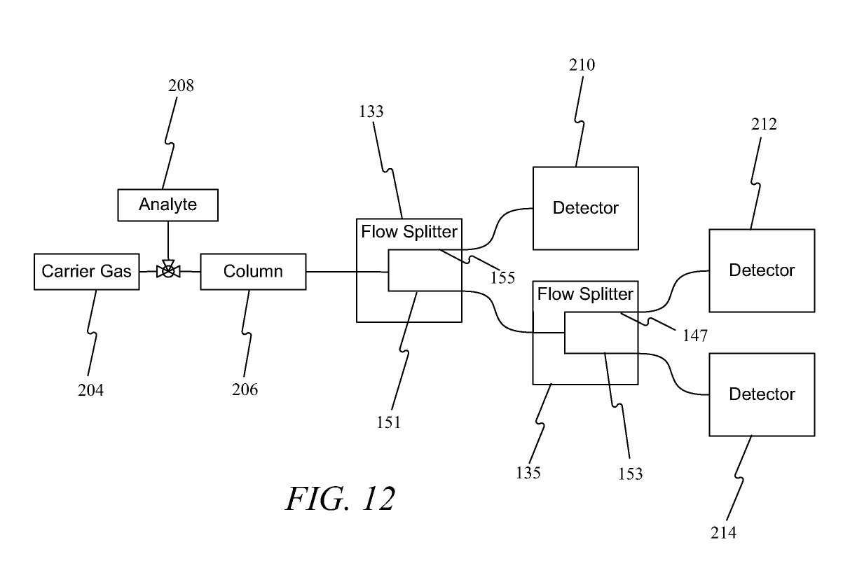

A network of flow paths for the carrier gas can include more than one flow splitter. In another example, illustrated in FIG. 12, a first flow splitter 133 receives carrier gas from the GC column 206 at a constant pressure. The first flow splitter 133 divides the gas stream and the first channel 155 guides a portion of the carrier gas to the first instrument 210. The second channel 151 guides the remainder of the carrier gas to a second flow splitter 135. The second flow splitter 135 receives the stream of carrier gas from the second channel 151 of the first flow splitter 133 and further divides the stream of carrier gas. The first channel 147 of the second flow splitter 135 guides a portion of the carrier gas to the second instrument 212 and the second channel 153 of the second flow splitter 135 guides the remainder of the carrier gas to a third instrument 214. Again, the flow rate of carrier gas through the first and second flow splitters 133 and 135 is set at a target level as described in more detail above. In this exemplary embodiment, the first and second flow splitters 133 and 135 provide restrictive elements to regulate the flow rate of the carrier gas.

Although applications to gas chromatography are described herein, flow controllers having a deformable wall also can be used in other applications such as liquid chromatography.

Many other embodiments of flow controllers having a deformable wall are possible in addition to those described herein. For example, the flow controller can have different configurations of channels and deformable materials providing resistive elements for controlling the flow of fluid through the channels. The flow controller also can have a single channel or a network of more than three channels as described herein. Anywhere from one to all of the channels can have a wall formed with a deformable material to provide a resistive element for control of the fluid flow.

Additionally, any combination of the channels can be in fluid communication with one another. For example, flow control devices as described herein can include channels that are not in fluid communication with each other, channels that are all in fluid communication with each other, or a combination channels that are not in fluid communication with another channel and a network of channels that are in fluid communication with each other. Additionally, a substrate can include channels at both the top and bottom surfaces of the substrate.

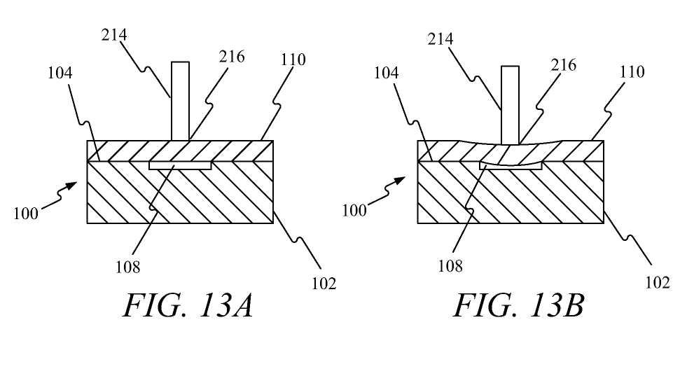

Mechanisms for deforming the deformable material and urging it in to the channel can include fluid pressure for selectively pressing against the external surface of the deformable material. Another possible mechanism is a mechanical structure, such as a plunger, for selectively pressing against the external surface of the deformable material. FIGS. 13A and 13B, for example, illustrate the flow controller 100 and a plunger 214. The plunger 214 directly opposes the channel 108 so that the deformable material 110 is positioned between the plunger 214 and the channel 108. The plunger 214 moves along a linear path that is orthogonal to the first surface 104 of the substrate 102. The plunger 214 has a first position (FIG. 13A) when the deformable material 110 has the first contour. The plunger 214 also has a second position (FIG. 13B) when the deformable material 110 is in the second contour. The end portion 216 of the plunger 214 that engages the deformable material 110 can have different shapes and dimensions. For example, the end portion 216 can have squared corners as illustrated or can be curved. Additionally, the shape of the end portion 216 can conform to the cross-sectional shape of the channel 108 so that contact with the end portion causes the deformable material 110 substantially to conform to the cross-sectional shape of the channel 108 when the plunger is in the second position.

Additionally, the plunger 214 can apply a force to a small area of the deformable material 110 so the plunger 214 applies a point load to the deformable material 110 as illustrated herein. Alternatively, the plunger 214 can be configured to apply a force distributed over a large area of the deformable material 110, including, for example, along the entire length of the channel 108, the entire width of the channel 108, or along both the entire length and width of the channel 108.

The first and second substrates and the deformable material can be formed with a variety of materials. Examples of materials that can be used to form the first and second substrates are metals that are chemically inert or can be passivated. Titanium is a metal having such properties. Other examples of materials that can be used to form the first and second substrates include insulators and semiconductors. Examples of deformable materials that can be used include polymers such as a polyimide. The deformable material has a coefficient of thermal expansion higher than the first and second substrates, which causes the deformable material to be placed under tensile stress when the substrates and deformable material are heated during the manufacturing process. The deformable material is chemically inert or is coated with a material to isolate it from the fluid flowing through the network of channels. The first and second substrates have a higher Young's modulus than the deformable material and are stiff as compared to the deformable material. The materials and physical characteristics of the materials disclosed herein are examples. The flow splitter can be fabricated using many other types of materials and materials having other physical characteristics.

In an exemplary fabrication process, the flow splitter is fabricated as a bonded metal/polymer/metal stack. The first substrate is formed using a dielectric hard mask that contains a pattern defining the network of channels. The hard mask is created by using photolithography. A layer of photoresist is spun onto a layer of dielectric material such as silicon nitride. The layer of photoresist is then subject to a photolithographic process, which defines the network of channels in the layer of photoresist. The dielectric material is etched in the pattern of network channels defined in the layer of photoresist to create the hard mask. The hard mask is applied to the first substrate and the first substrate is etched.

Alternatively, the titanium substrate can go through two wet etch steps, one shallow and one deeper, to create channels with different aspect ratios. In this alternative etching process, the shallow etch is typically performed first because deep etched features in the titanium substrate can interfere with the subsequent spin-on photoresist processes. The cavities in the second substrate are formed using a similar process. The first and second substrates can be processed in bulk by etching the channels for multiple flow controllers into a single wafer, bonding the layers together, and then separating the individual flow controllers. Additionally, the channels can be micromachined into a substrate using other types of etching techniques, as well as techniques other than etching. The layers of substrate and deformable material are registered before bonding so that the vias, channels, and cavities are aligned as disclosed above.

The first substrate can be coated with a thin film to increase the substrate's chemical inertness to analytes. A chemically inert thin film is applied to locations of the deformable material that may come into contact with fluid if the deformable material is not chemically inert or if it is desired to increase the inertness of the deformable material. The chemically inert thin film is patterned with a suitable technique such as shadow masking.

Vias and alignment holes in the deformable material and in the second substrate are machined using laser ablation. The first substrate, deformable material, and second substrate are then stacked in alignment and are bonded together using heat and pressure. When the flow controller is intended for use in gas chromatography, the bonding temperature is at or above the maximum temperature used during gas chromatography. Otherwise the bonding temperature is at or above the maximum temperature used in the application that will utilize the flow controller. When the deformable material has a coefficient of thermal expansion greater than that of the first and second substrates, bonding the deformable material to the first and second substrates at an elevated temperature will cause the deformable material to be under tensile stress during operation of the flow splitter at a temperature less than the bonding temperature. This tensile stress prevents the deformable material from buckling. Deformable materials can be attached to substrates using a variety of different techniques in addition to bonding with pressure and heat.

The various embodiments described above are provided by way of illustration only and should not be construed to limit the claims attached hereto. Various modifications and changes that may be made without following the example embodiments and applications illustrated and described herein, and without departing from the scope of the invention defined by the following claims.

We claim:

1. An apparatus for controlling the flow of fluid though a channel, the apparatus comprising:
a first substrate defining features comprising a first channel; and
a deformable material bounding at least a portion of the first channel, the deformable material having a first contour in which the first channel has a first cross-sectional area and a second contour in which the first channel has a second cross-sectional area.

2. The apparatus of claim 1, wherein the channel is a microfluidic channel.

3. The apparatus of claim 2, wherein the cross-section has a width and a depth, the width being substantially greater than the depth.

4. The apparatus of claim 2, wherein the width is about 1000 μm and the depth is about 20 μm.

5. The apparatus of claim 2, wherein fluid flow through the first channel is blocked when the deformable material has the second contour and the first channel has the second cross-sectional area.

6. The apparatus of claim 1, wherein first substrate has a curved wall defining the first channel, the curved wall generally conforming to the second contour.

7. The apparatus of claim 1, wherein at least a portion of the deformable material is under tension when the deformable material has the first contour and when the deformable material has the second contour.

8. The apparatus of claim 1, wherein the first substrate has a first coefficient of thermal expansion and the deformable material has a second coefficient of thermal expansion, the first coefficient of thermal expansion being about equal to or less than the second coefficient of thermal expansion.

9. The apparatus of claim 1, wherein:
the features defined by the first substrate additionally comprise a second channel;
the first channel comprises an outlet and a region providing fluid communication with the second channel; and
the deformable material is selectively deformable between the first contour and the second contour at a location along the first channel and between the region and the outlet.

10. The apparatus of claim 9, further comprising a second substrate, the deformable material positioned between the first substrate and the second substrate.

11. The apparatus of claim 10, wherein the second substrate has a surface positioned against the deformable material, the second substrate defining features comprising:
a cavity;
an opening between the cavity and the deformable material, the opening located opposite the first channel in the first substrate; and
a pressure via in fluid communication with the cavity.

12. The apparatus of claim 9, wherein:
the features defined by the first substrate additionally comprise a third channel in fluid communication with the first and second channels; and
the deformable material additionally bounds at least a portion of the third channel, the deformable material having a third contour in which the third channel has a first cross-sectional area and a fourth contour in which the third channel has a second cross-sectional area.

13. The apparatus of claim 1, further comprising:
a chromatography column arranged to input fluid into the first channel; and
a detector arranged to receive fluid from the first channel.

14. A flow splitter, comprising:
a first substrate having a surface and defining features comprising a first channel and a second channel, the first channel comprising an outlet and a region in fluid communication with the second channel, the substrate additionally defining an opening between at least a portion of the first channel and the surface, the opening located between the region and the outlet, the first channel having a width and a depth, the width substantially greater than the depth;
a second substrate defining features comprising a cavity and an opening, the opening located opposite the opening in the first substrate; and
a deformable material between the first substrate and the second substrate, the deformable material positioned for selective deformation through the opening, the deformable material having a first contour in which the first channel has a first cross-sectional area and a second contour in which the first channel has a second cross-sectional area, wherein at least the portion of the deformable material positioned for selective deformation through the opening is under tension when the deformable material has the first contour and when the deformable material has the second contour.

15. A method for controlling fluid flow through a channel, the method comprising:
providing a network of channels, the network of channels comprising a first channel bounded by a deformable material;
passing fluid into the network of channels; and
deforming the deformable material of the first channel to change the first channel from a first cross-sectional area to a second cross-sectional area.

16. The method of claim 15, wherein the deforming comprises:
applying force to the deformable material.

17. The method of claim 16 wherein the applying force comprises:
applying fluid pressure to the deformable material.

18. The method of claim 16 wherein the applying force comprises:
applying force to the deformable material mechanically.

19. The method of claim 15, wherein the deforming comprises:
applying a point load to the deformable material.

20. The method of claim 15, wherein the deforming comprises:
deforming the deformable material so as to substantially stop fluid flow through the first channel.

21. The method of claim 15, further comprising:
measuring the flow rate of fluid flowing through the first channel;
adjusting the deformation of the deformable material to change the flow rate of fluid flowing through the first channel; and
repeating the measuring and the adjusting until fluid flows through the first channel at a target flow rate.

22. The method of claim 15, further comprising:
deforming the deformable material to change the first channel from the second cross-sectional area to a third cross-sectional area.

23. The method of claim 15, wherein:
the network of channels additionally comprises a second channel;
the first channel comprises an outlet and a region providing fluid communication with the second channel;
the method additionally comprises passing fluid into the second channel; and
the deforming the deformable material of the first channel occurs between the region and the outlet.

24. The method of claim 23, further comprising:
measuring the flow rate of fluid flowing through the second channel;
adjusting the deformation of the deformable material to change the flow rate of fluid flowing through the second channel; and
repeating the measuring and the adjusting until fluid flows through the second channel at a target flow rate.

25. The method of claim 23, wherein the network of channels additionally comprises a third channel, the third channel comprising an outlet and a region in fluid communication with the first channel and the second channel, the third channel comprising a deformable material, the method additionally comprising:
passing fluid into the third channel; and
deforming the deformable material of the third channel at a location between the region of the third channel and the outlet of the third channel.
